(19) United States
(12) Patent Application Publication
(10) Pub. No.: US 2021/0268905 A1
(43) Pub. Date: Sep. 2, 2021

(54) VEHICLE DRIVING ASSISTANCE SYSTEM, VEHICLE DRIVING ASSISTANCE METHOD, AND VEHICLE DRIVING ASSISTANCE PROGRAM

(71) Applicant: AISIN AW CO., LTD., Anjo-shi, Aichi (JP)

(72) Inventor: Seiya NAKANO, Okazaki (JP)

(73) Assignee: AISIN AW CO., LTD., Anjo-shi, Aichi (JP)

(21) Appl. No.: 17/258,575

(22) PCT Filed: Aug. 20, 2019
(86) PCT No.: PCT/JP2019/032464

§ 371 Date: Jan. 7, 2021

(30) Foreign Application Priority Data
Aug. 22, 2018 (JP) 2018-155693

(51) Int. Cl. B60K 35/00; G07C 5/08; G08G 1/16

(52) U.S. Cl. CPC B60K 35/00; G07C 5/085; B60K 2370/166; B60K 2370/178; G08G 1/166

(57) ABSTRACT

A vehicle driving assistance system includes a display part that displays an attention-calling marking (M) so as to be superimposed on a real view (S); a driver's vehicle information obtaining part that obtains driver's vehicle information including information indicating a moving state of a driver's vehicle; a moving object information obtaining part that obtains moving object information including information indicating a moving state of a moving object (90) around the driver's vehicle; and an attention-calling part that allows the display part to display the attention-calling marking (M) based on the driver's vehicle information and the moving object information, the attention-calling marking (M) using, as a reference, a closest approach point (P) where the driver's vehicle and the moving object (90) make closest approach to each other in the future.

### CROSS REFERENCE TO RELATED APPLICATIONS

This application is a National Stage of International Application No. PCT/JP2019/032464 filed Aug. 20, 2019, which designates the United States, incorporated herein by reference, and which claims the benefit of priority from Japanese Patent Application No. 2018-155693 filed Aug. 22, 2018, the entire contents of which are incorporated herein by reference.

### TECHNICAL FIELD

The present disclosure relates to a vehicle driving assistance system, a vehicle driving assistance method, and a vehicle driving assistance program that display an attention-calling marking so as to be superimposed on a real view.

### BACKGROUND ART

An example of a system that displays information so as to be superimposed on a real view is disclosed in JP 2009-64088 A (Patent Literature 1). Specifically, paragraph 0037 and FIG. 5 of Patent Literature 1 describe that regions each indicating a course with a probability greater than or equal to a predetermined value among predicted courses of another vehicle which is an obstacle are displayed superimposed in translucent color on a windshield of a driver's vehicle. Paragraph 0038 of Patent Literature 1 describes that by performing such superimposed display, a driver of the driver's vehicle can recognize regions where there are possible dangerous occurrences in the near future.

As described above, in a technique described in Patent Literature 1, it is configured such that a future estimated moving route for a moving object around the driver's vehicle (hereinafter, simply referred to as “moving object”) is displayed on a display part. Here, a point where the moving object actually influences travel of the driver's vehicle changes depending on the difference in moving speed between the driver's vehicle and the moving object, spacing between the driver's vehicle and the moving object, traveling directions of the driver's vehicle and the moving object, etc. However, in the technique described in Patent Literature 1, since an estimated moving route that uses a current location of the moving object as a reference is displayed, it has not been easy for the driver of the driver's vehicle to grasp a point where the moving object can influence travel of the driver's vehicle, from the displayed estimated moving route of the moving object. Hence, there has been a case in which it is not easy for the driver to appropriately recognize timing at which an operation of avoiding the moving object (a braking operation, a steering operation, etc.) is to be performed.

### CITATIONS LIST

### Patent Literature

Patent Literature 1: JP 2009-64088 A

### SUMMARY OF THE DISCLOSURE

### Technical Problems

It is therefore desired to implement a technique that can allow the driver of the driver's vehicle to easily grasp a point where a moving object around the driver's vehicle can influence future travel of the driver's vehicle.

### Solutions to Problems

A characteristic configuration of a vehicle driving assistance system in view of the above description is that the vehicle driving assistance system includes: a display part that displays an attention-calling marking so as to be superimposed on a real view; a driver's vehicle information obtaining part that obtains driver's vehicle information including information indicating a moving state of a driver's vehicle; a moving object information obtaining part that obtains moving object information including information indicating a moving state of a moving object around a driver's vehicle; and an attention-calling part that allows the display part to display the attention-calling marking based on the driver's vehicle information and the moving object information, the attention-calling marking using, as a reference, a closest approach point where a driver's vehicle and the moving object make closest approach to each other in a future.

In addition, technical features of the vehicle driving assistance system in view of the above description can also be applied to a vehicle driving assistance method and a vehicle driving assistance program, and such a method and a program, and furthermore, a storage medium (e.g., an optical disc, a flash memory, etc.) having such a program stored therein are also disclosed in this specification.

A characteristic configuration of the vehicle driving assistance method in that case is that the vehicle driving assistance method includes: a displaying step of allowing a display part to display an attention-calling marking so as to be superimposed on a real view; a driver's vehicle information obtaining step of obtaining driver's vehicle information including information indicating a moving state of a driver's vehicle; a moving object information obtaining step of obtaining moving object information including information indicating a moving state of a moving object around a driver's vehicle; and an attention-calling step of allowing the display part to display the attention-calling marking based on the driver's vehicle information and the moving object information, the attention-calling marking using, as a reference, a closest approach point where a driver's vehicle and the moving object make closest approach to each other in a future.

In addition, a characteristic configuration of the vehicle driving assistance program in that case is that the vehicle driving assistance program allows a computer to implement: a display function of allowing a display part to display an attention-calling marking so as to be superimposed on a real view; a driver's vehicle information obtaining function of obtaining driver's vehicle information including information indicating a moving state of a driver's vehicle; a moving object information obtaining function of obtaining moving object information including information indicating a moving state of a moving object around a driver's vehicle; and an attention-calling function of allowing the display part to display the attention-calling marking based on the driver's vehicle information and the moving object information, the attention-calling marking using, as a reference, a closest approach point where a driver's vehicle and the moving object make closest approach to each other in a future.

According to these configurations, by allowing the display part to display an attention-calling marking, a driver of the driver's vehicle can recognize the presence of a moving object that can influence travel of the driver's vehicle. According to these configurations, the display part can be allowed to display an attention-calling marking that uses, as a reference, a closest approach point where the driver's vehicle and the moving object make closest approach to each other in the future, i.e., an attention-calling marking that uses, as a reference, a point where the influence of the moving object on travel of the driver's vehicle can be greatest. Thus, compared to a case in which an attention-calling marking that uses a current location of a moving object as a reference is displayed on the display part, the driver of the driver's vehicle can easily grasp a point where a moving object around the driver's vehicle can influence future travel of the driver's vehicle.

Further features and advantages of the vehicle driving assistance system, the vehicle driving assistance method, and the vehicle driving assistance program will become more apparent from the following description of embodiments which are described with reference to drawings.

### BRIEF DESCRIPTION OF DRAWINGS

FIG. 1 is a perspective view showing an example of a state of an area around a driver's seat of a vehicle.

FIG. 2 is a block diagram schematically showing an example of a system configuration of a vehicle driving assistance system.

FIG. 3 is a diagram showing an example of a state in which an attention-calling marking is displayed superimposed on a real view.

FIG. 4 is a diagram showing a situation around the driver's vehicle at a scene shown in FIG. 3.

FIG. 5 is an illustrative diagram of an attention call level distribution represented by the attention-calling marking of FIG. 3.

FIG. 6 is a diagram showing another example of a situation in which an attention-calling marking is displayed on a display part.

FIG. 7 is a diagram showing an example of time-series changes in the location of the driver's vehicle and the location of a moving object.

FIG. 8 is a diagram showing another example of time-series changes in the location of the driver's vehicle and the location of a moving object.

FIG. 9 is a block diagram showing functional parts of an arithmetic processing unit.

FIG. 10 is a flowchart showing an example of a procedure of a vehicle driving assistance process.

### DESCRIPTION OF EMBODIMENTS

An embodiment of a vehicle driving assistance system (including a vehicle driving assistance method and a vehicle driving assistance program) will be described below based on the drawings. A vehicle driving assistance system 10 is a system that provides a driver with information for assisting in driving, and provides the driver with information for assisting in driving by displaying an attention-calling marking M so as to be superimposed on a real view S (see FIG. 3). Namely, it can be said that the vehicle driving assistance system 10 is an attention-calling system that displays an attention-calling marking M so as to be superimposed on a real view S.

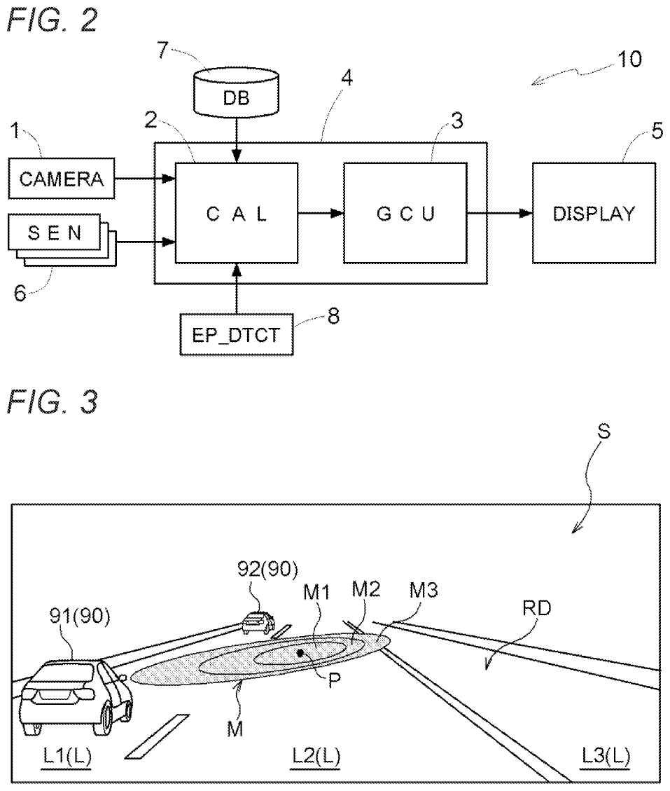

Note that the vehicle driving assistance method is, for example, a method for providing driving assistance by using hardware and software that form the vehicle driving assistance system 10 such as those which will be described later with reference to FIG. 2, etc. Note also that the vehicle driving assistance program is, for example, a program that is executed on a computer (e.g., an arithmetic processing unit 4 which will be described later with reference to FIG. 2) included in the vehicle driving assistance system 10, to implement vehicle driving assistance functions (including a display function, a driver's vehicle information obtaining function, a moving object information obtaining function, and an attention-calling function which will be described later).

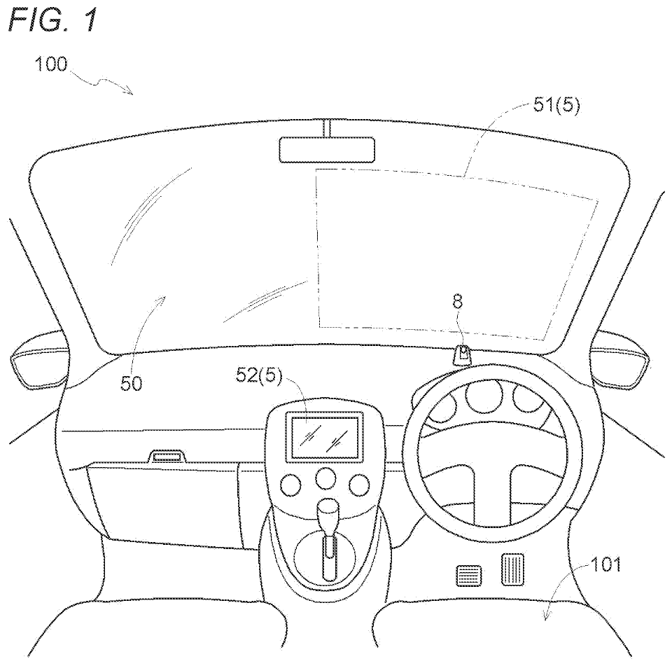

A real view S on which an attention-calling marking M is superimposed may be a view seen from a driver's seat 101 through a windshield 50 of a driver's vehicle 100 (see FIG. 1) or may be video that is shot by a camera 1 (see FIG. 2) which will be described later, and shown on a monitor 52. When the real view S is a view seen through the windshield 50, an attention-calling marking M is, for example, rendered on a head-up display 51 which is formed on the windshield 50, and superimposed on the real view S. A dashed-double-dotted-line region shown in the windshield 50 in FIG. 1 is a region in which the head-up display 51 is formed. In addition, when the real view S is video shown on the monitor 52, an attention-calling marking M is superimposed on the video.

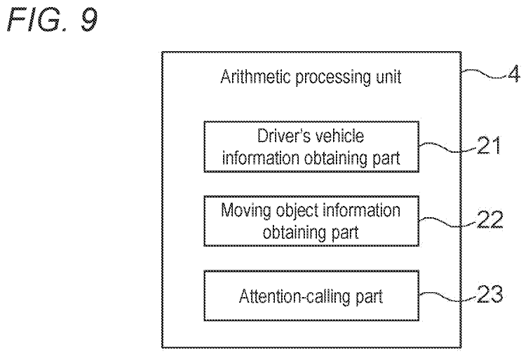

As shown in FIG. 2, the vehicle driving assistance system 10 includes the camera 1 (CAMERA), an arithmetic processing device 2 (CAL), a graphic control unit 3 (GCU), and a display part 5 (DISPLAY). One or more cameras 1 are provided to shoot an area around (at least the front of) the driver's vehicle 100. The graphic control unit 3 (graphic controller) controls the display part 5 to display an attention-calling marking M on the display part 5. In the present embodiment, the arithmetic processing device 2 and the graphic control unit 3 are formed as a part of the arithmetic processing unit 4 which is formed as a single processor (a system LSI, a digital signal processor (DSP), etc.) or a single electronic control unit (ECU). As shown in FIG. 9, the arithmetic processing unit 4 includes a plurality of functional parts including a driver's vehicle information obtaining part 21, a moving object information obtaining part 22, and an attention-calling part 23. The display part 5 is a display device that displays an attention-calling marking M so as to be superimposed on a real view S. Here, the display part 5 includes at least one of the above-described head-up display 51 and monitor 52. As such, the vehicle driving assistance system 10 includes the display part 5, the driver's vehicle information obtaining part 21, the moving object information obtaining part 22, and the attention-calling part 23.

In the present embodiment, the vehicle driving assistance system 10 further includes a sensor group 6 (SEN), a database 7 (DB), and an eyepoint detection device 8 (EP_DTCT). The sensor group 6 can include sonar, radar, a vehicle speed sensor, a yaw-rate sensor, a global positioning system (GPS) receiver, etc. The database 7 is a database having stored therein map information, road information, ground object information (information on traffic signs, road markings, facilities, etc.), etc. In the present embodiment, the database 7 stores therein information on the types of moving objects 90 which will be described later and information on patterns (templates) of an attention call level distribution AD which will be described later. The eyepoint detection device 8 is configured to include, for example, a camera that shoots a driver's head, and detects a driver's eyepoint (eyes). It is preferred that an attention-calling marking M which is rendered on the head-up display 51 be rendered at a location appropriate to the driver's eyepoint.

As described above, the arithmetic processing unit 4 includes a plurality of functional parts including the driver's vehicle information obtaining part 21, the moving object information obtaining part 22, and the attention-calling part 23. The plurality of functional parts are composed of software (program) stored in a storage device (a storage device included in the arithmetic processing unit 4, etc.) or additionally provided hardware such as an arithmetic circuit, or both of them. The plurality of functional parts are at least logically distinguished from each other and do not necessarily need to be physically distinguished from each other. In addition, the plurality of functional parts do not need to be implemented by hardware shared therebetween, and may be separately implemented by a plurality of pieces of hardware that can communicate with each other (e.g., an in-vehicle device mounted on the driver's vehicle 100 and a device outside the driver's vehicle (a server, etc.) which is provided external to the driver's vehicle 100).

The driver's vehicle information obtaining part 21 is a functional part that obtains driver's vehicle information including information indicating a moving state of the driver's vehicle 100. The moving state of the driver's vehicle 100 includes the moving direction and moving speed of the driver's vehicle 100. The moving state of the driver's vehicle 100 may include the location (e.g., coordinates represented by latitude and longitude) of the driver's vehicle 100. The driver's vehicle information obtaining part 21 estimates (estimates and determines) a moving state of the driver's vehicle 100 using at least any one of information provided from the sensor group 6, an image recognition result for an image shot by the camera 1, information stored in the database 7, and information obtained by communication (e.g., road-to-vehicle communication between the driver's vehicle 100 and a communication device installed on a road side). In the present embodiment, a process performed by the driver's vehicle information obtaining part 21 corresponds to a “driver's vehicle information obtaining step”, and a function implemented by performing the process corresponds to a “driver's vehicle information obtaining function”.

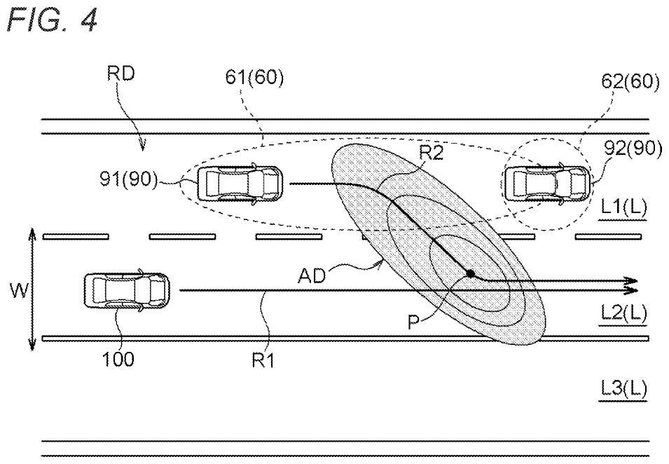

The moving object information obtaining part 22 is a functional part that obtains moving object information including information indicating a moving state of a moving object 90 around the driver's vehicle 100. As shown in FIG. 4, when there are a plurality of moving objects 90 around the driver's vehicle 100, the moving object information obtaining part 22 obtains moving object information of each of the plurality of moving objects 90. Note that the moving objects 90 are objects that can hinder travel of the driver's vehicle 100, and are objects that are moving (e.g., other vehicles that are moving) or objects that are likely to move (e.g., other vehicles being stopped). Namely, the moving objects 90 are not static obstacles (traffic signs, utility poles, curves, etc.) fixed to roads, etc., but are dynamic obstacles. In the following description, the moving objects 90 indicate moving objects 90 around the driver's vehicle 100.

The moving state of a moving object 90 includes the location (e.g., coordinates represented by latitude and longitude), moving direction, and moving speed of the moving object 90. The location of the moving object 90 may be an absolute location or a relative location (e.g., a relative location to the driver's vehicle 100). The moving object information obtaining part 22 estimates a moving state of the moving object 90 using at least any one of information provided from the sensor group 6, an image recognition result for an image shot by the camera 1, information stored in the database 7, and information obtained by communication (e.g., vehicle-to-vehicle communication between the driver's vehicle 100 and the moving object 90 when the moving object 90 is a vehicle). In the present embodiment, a process performed by the moving object information obtaining part 22 corresponds to a “moving object information obtaining step”, and a function implemented by performing the process corresponds to a “moving object information obtaining function”.

In the present embodiment, moving object information obtained by the moving object information obtaining part 22 includes information indicating the type of the moving object 90 in addition to information indicating the moving state of the moving object 90. In the present embodiment, the types of moving objects 90 include vehicles (automatic four-wheeled vehicles), automatic two-wheeled vehicles, bicycles, and pedestrians. The moving object information obtaining part 22 estimates the type of the moving object 90 using at least any one of information provided from the sensor group 6, an image recognition result for an image shot by the camera 1, information stored in the database 7, and information obtained by communication (e.g., vehicle-to-vehicle communication).

The attention-calling part 23 is a functional part that allows the display part 5 to display an attention-calling marking M. Specifically, the attention-calling part 23 allows the display part 5 to display an attention-calling marking M so as to be superimposed on a real view S (see FIG. 3). As will be described later, the attention-calling part 23 creates an attention-calling marking M based on driver's vehicle information and moving object information. The attention-calling marking M is represented, for example, in a mode in which the driver of the driver's vehicle 100 can visually recognize the attention-calling marking M, distinguishing the attention-calling marking M from the real view S, by characters, graphics, symbols, or a combination thereof. As shown in FIG. 3, in the present embodiment, an attention-calling marking M is represented by a planar-shaped graphic lying along a road surface (a surface of a road RD). Note that the attention-calling marking M is superimposed on a real view S in a mode in which the attention-calling marking M does not interfere with driving operations by the driver of the driver's vehicle 100. For example, the attention-calling marking M is rendered in translucent color so that the driver can visually recognize a portion of the real view S (the road surface, etc.) behind the attention-calling marking M. In the present embodiment, a process performed by the attention-calling part 23 corresponds to a “displaying step” and an “attention-calling step”, and functions implemented by performing the process correspond to a “display function” and an “attention-calling function”.

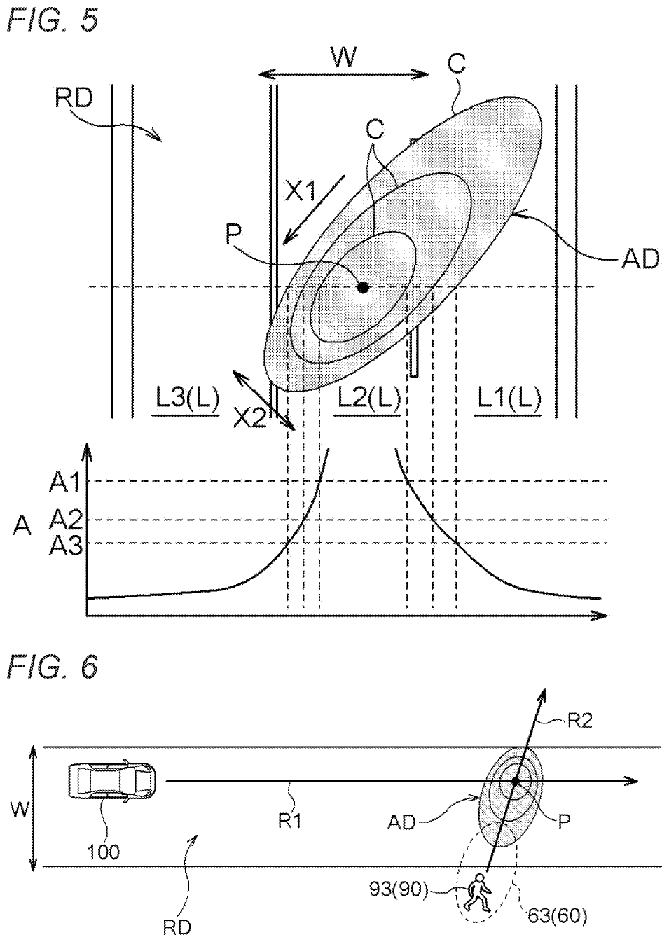

The attention-calling marking M is a marking representing the magnitude of an attention call level A (the degree of attention call). Specifically, the attention-calling marking M is a marking representing an attention call level distribution AD which is a distribution of the attention call level A (a distribution in a plane along the road surface). The attention-calling marking M is displayed superimposed on the real view S in a mode in which the driver of the driver's vehicle 100 who looks at the road surface in a direction oblique to a direction orthogonal to the road surface can recognize the attention call level distribution AD. For example, in an example shown in FIG. 3, taking into account a line-of-sight direction of the driver of the driver's vehicle 100, an attention-calling marking M is displayed superimposed on a real view S in a mode in which the driver of the driver's vehicle 100 can recognize an attention call level distribution AD shown in FIG. 4. In the present embodiment, the attention-calling marking M is displayed in a mode in which the attention-calling marking M represents an attention call level distribution AD in a range in which the attention call level A greater than or equal to a predetermined threshold value (here, a third threshold value A3 which will be described later, see FIG. 5) is distributed.

The attention call level A represents the level of influence of a moving object 90 on travel of the driver's vehicle 100. In the present embodiment, the magnitude of the attention call level A is the level of possibility of presence (probability of presence) of a moving object 90. Namely, in the present embodiment, the attention-calling marking M is a marking representing the level of possibility of presence of a moving object 90. When the attention call level A is the possibility of presence of a moving object 90 as such, as shown in FIG. 5, the attention call level distribution AD is a distribution in which with a location with the highest attention call level A (here, a closest approach point P which will be described later) serving as a reference location, the attention call level A continuously decreases as moving away (moving away along the road surface) from the reference location. Namely, the attention call level distribution AD is equivalent to a risk potential distribution used in a potential method. Note that in FIGS. 4 to 8 the attention call level distribution AD is represented by contour lines C each connecting points of equal magnitude of the attention call level A (see FIG. 5), and a region in which the attention call level A is greater than or equal to a threshold value (here, the third threshold value A3 which will be described later) is hatched.

The potential method is publicly known and thus a detailed description thereof is omitted, but in the potential method, a risk potential indicating the possibility of collision (collision risk) is set for obstacles, etc., and a recommended route is derived based on the gradient of the overall potential. Note that the overall potential is generated by, for example, taking the sum of risk potentials and providing a gradient heading toward a destination. FIG. 4 shows an example of a distribution of a risk potential 60 (first risk potential distribution 61) set for a moving vehicle (first vehicle 91), and an example of a distribution of a risk potential 60 (second risk potential distribution 62) set for a vehicle being stopped (second vehicle 92). In addition, FIG. 6 shows an example of a distribution of a risk potential 60 (third risk potential distribution 63) set for a moving pedestrian 93. Here, each of the risk potential distributions (61, 62, and 63) is represented by a line segment (dashed line) that encloses a region in which the magnitude of the risk potential 60 is greater than or equal to a threshold value.

The attention-calling part 23 allows the display part 5 to display an attention-calling marking M that uses a closest approach point P as a reference, based on driver's vehicle information and moving object information (see FIG. 3). Here, the closest approach point P is a point where the driver's vehicle 100 and a moving object 90 make closest approach to each other in the future, and is estimated based on driver's vehicle information and moving object information as will be described later. Namely, the attention-calling part 23 allows the display part 5 to display an attention-calling marking M that uses, as a reference, a closest approach point P which is a point where the influence of the moving object 90 on travel of the driver's vehicle 100 can be greatest. By thus allowing the display part 5 to display the attention-calling marking M that uses the closest approach point P as a reference, compared to a case in which an attention-calling marking M that uses a current location of the moving object 90 as a reference (e.g., an attention-calling marking M representing the above-described first risk potential distribution 61) is displayed on the display part 5, the driver of the driver's vehicle 100 can easily grasp a point where a moving object 90 around the driver's vehicle 100 can influence future travel of the driver's vehicle 100. Namely, by the attention-calling marking M that uses the closest approach point P as a reference being displayed superimposed on the real view S, it becomes easier for the driver of the driver's vehicle 100 to perform driving operations taking into account the presence of a moving object 90 that can influence travel of the driver's vehicle 100. Note that as information for assisting in driving, a recommended route, etc., for the driver's vehicle 100 may be displayed superimposed on the real view S, in addition to the attention-calling marking M.

As described above, in the present embodiment, the attention-calling marking M is a marking representing the level of possibility of presence of a moving object 90, and thus, an attention-calling marking M that uses a closest approach point P as a reference is a marking representing the level of possibility of presence of a moving object 90 at the point in time of closest approach. Here, the point in time of closest approach is the point in time when the driver's vehicle 100 and the moving object 90 make closest approach to each other in the future (in other words, the point in time when the distance between the driver's vehicle 100 and the moving object 90 is shortest in the future), and is estimated based on driver's vehicle information and moving object information as will be described later. In the present embodiment, as will be described later, a location of the moving object 90 at the point in time of closest approach is set as a closest approach point P, and thus, as shown in FIG. 5, the possibility of presence of the moving object 90 which is the attention call level A is highest at the closest approach point P, and decreases as moving away (moving away along the road surface) from the closest approach point P. Thus, the attention-calling marking M representing such a distribution of the attention call level A (attention call level distribution AD) is a marking in which the possibility of presence (attention call level A) at the closest approach point P is highest and the possibility of presence (attention call level A) decreases as moving away (moving away along the road surface) from the closest approach point P. Namely, the attention-calling marking M is displayed in a mode in which the closest approach point P (in the present embodiment, the location of the moving object 90 at the point in time of closest approach) can be recognized.

In addition, in the present embodiment as shown in FIG. 5, the attention call level distribution AD is generated such that the length in a first direction X1 of a region enclosed by a contour line C (i.e., a region in which the attention call level A is greater than or equal to a predetermined threshold value) is long compared to the length in a second direction X2 of the region. Here, the first direction X1 is the moving direction of the moving object 90. Specifically, the first direction X1 is the moving direction of the moving object 90 at the location of the moving object 90 at the point in time of closest approach (in the present embodiment, the closest approach point P) (in other words, the moving direction of the moving object 90 at the point in time of closest approach), and is estimated based on moving object information. The moving direction may be an average moving direction during a period having the point in time of closest approach as an end point. In addition, the second direction X2 is a direction orthogonal to the moving direction of the moving object 90 (i.e., a direction orthogonal to the first direction X1). Note that the second direction X2 is not a direction orthogonal to the first direction X1 as viewed from the driver of the driver's vehicle 100, but is a direction orthogonal to the first direction X1 in a plane along the road surface.

In the present embodiment, since the attention-calling marking M represents the attention call level distribution AD such as that described above, the length in the first direction X1 of the attention-calling marking M is long compared to the length in the second direction X2 of the attention-calling marking M. Thus, the attention-calling marking M is displayed in a mode in which the first direction X1 can be recognized, i.e., a mode in which the moving direction of the moving object 90 at the closest approach point P (in other words, the moving direction of the moving object 90 at the point in time of closest approach) can be recognized. In the present embodiment, the attention-calling marking M is displayed in a mode in which the attention-calling marking M represents a region in which the attention call level A is greater than or equal to a predetermined threshold value (here, the third threshold value A3 which will be described later). Hence, the lengths in the first direction X1 and second direction X2 of the attention-calling marking M are determined based on the size of a distribution range in the first direction X1 and second direction X2 of the attention call level distribution AD in which the attention call level A greater than or equal to the above-described threshold value is distributed.

In examples shown in FIGS. 4 and 5, an attention call level distribution AD is generated such that a region enclosed by a contour line C is an elliptical region having the major axis along the first direction X1, as viewed in a direction orthogonal to the road surface. Accordingly, as shown in FIG. 3, the attention-calling marking M is also represented by an elliptical graphic lying along the road surface. The length of the major axis of the ellipse can be set, for example, to increase as the moving speed of the moving object 90 at the point in time of closest approach increases. In this case, the attention-calling marking M is displayed in a mode in which the moving speed of the moving object 90 at the closest approach point P (in other words, the moving speed of the moving object 90 at the point in time of closest approach) can be recognized.

As shown in FIG. 3, in the present embodiment, the attention-calling marking M is displayed in a mode in which changes in the attention call level A (here, the possibility of presence of a moving object 90) are shown in a stepwise manner. Namely, the attention-calling marking M is displayed in a mode in which continuous changes in the attention call level A (see FIG. 5) are shown in a stepwise manner. FIG. 3 exemplifies a case in which the attention-calling marking M is displayed in a mode in which the attention call level A is shown divided into four levels (an example of a plurality of levels). As shown in FIG. 5, when threshold values that divide the attention call level A into four levels are, from high to low, a first threshold value Al, a second threshold value A2, and a third threshold value A3, the attention-calling marking M shown in FIG. 3 is displayed in a mode in which the attention-calling marking M shows a first region M1 indicating that the attention call level A is greater than or equal to the first threshold value A1, a second region M2 indicating that the attention call level A is less than the first threshold value A1 and greater than or equal to the second threshold value A2, and a third region M3 indicating that the attention call level A is less than the second threshold value A2 and greater than or equal to the third threshold value A3. The first region M1 is a region with the highest attention call level A and thus is set to include a closest approach point P.

In order to make it easier to visually recognize a plurality of regions (here, the first region M1, the second region M2, and the third region M3) represented by the attention-calling marking M, such that the regions are distinguished from each other, it is preferred that the plurality of regions be displayed in different colorations, different patterns, etc. The “coloration” used herein includes not only color and chroma, but also shades. In this case, it is preferred that the coloration of each region be set, for example, to call more attention as the attention call level A increases, based on cognitive engineering, etc. For example, the first region M1 can be displayed in red color, the second region M2 can be displayed in orange color, and the third region M3 can be displayed in yellow color. In addition, it is also preferred that the coloration of each region be set such that density or chroma increases as the attention call level A increases.

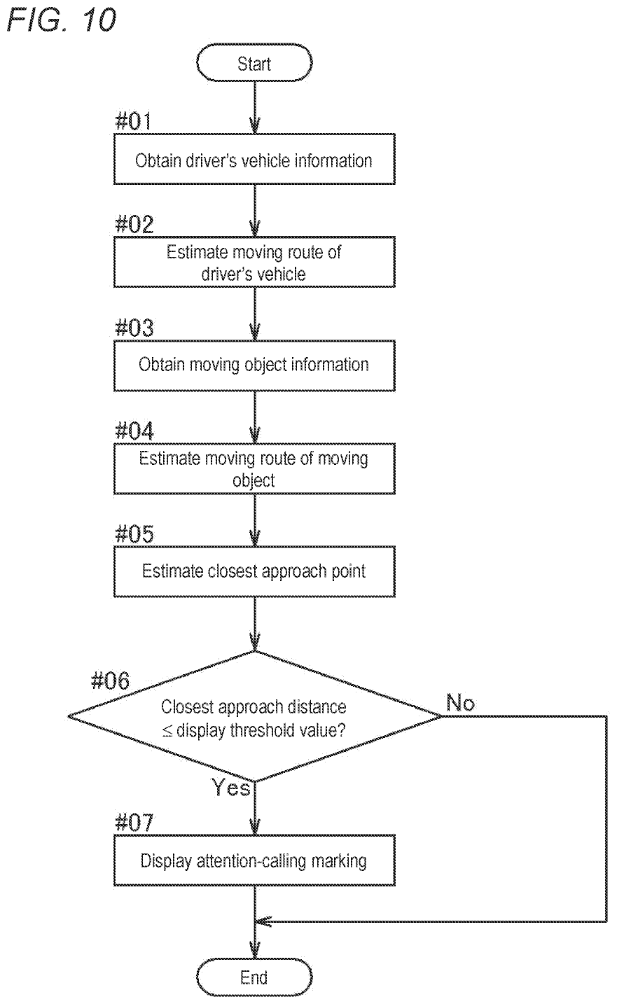

Next, with reference to FIG. 10, etc., a processing procedure of a vehicle driving assistance process performed by the vehicle driving assistance system 10 of the present embodiment will be described. The vehicle driving assistance process is performed when there is a moving object 90 around the driver's vehicle 100. Each step described below is performed by the arithmetic processing device (computer) included in the vehicle driving assistance system 10. Note that the order of performing four steps (step #01, step #02, step #03, and step #04) shown in FIG. 10 is an example, and the order of performing the four steps can be changed as appropriate as long as the order in which step #02 is performed after step #01 and the order in which step #04 is performed after step #03 are maintained, and the configuration may be such that a plurality of steps (e.g., step #01 and step #03 or step #02 and step #04) are performed simultaneously or in the same time frame.

First, the driver's vehicle information obtaining part 21 obtains driver's vehicle information (step #01), and the attention-calling part 23 estimates a driver's vehicle estimated route R1 which is a future moving route of the driver's vehicle 100, based on the driver's vehicle information (step #02). The driver's vehicle estimated route R1 can be, for example, a route that is estimated without taking into account the presence of a moving object 90 around the driver's vehicle 100.

For example, a moving route of the driver's vehicle 100 adopted when, as shown in FIGS. 4 and 6, the driver's vehicle 100 continues to move on a road RD on which the driver's vehicle 100 is currently moving, in an extending direction of the road RD at the same speed as the current speed without making a lane change or a left or right turn can be set as a driver's vehicle estimated route R1. Specifically, in a situation shown in FIG. 4, a moving route of the driver's vehicle 100 adopted when the driver's vehicle 100 is moving on a road RD having lanes L (specifically, three lanes L including a first lane L1, a second lane L2, and a third lane L3) and continues to move on a lane L (here, the second lane L2) on which the driver's vehicle 100 is currently moving, at the same speed as the current speed in the future, too, is set as a driver's vehicle estimated route R1. In this case, the position in a width direction of the road RD (road width direction W) of the driver's vehicle 100 to determine the driver's vehicle estimated route R1 can be, for example, the middle position of the lane L. Note that when, like a situation shown in FIG. 6, the driver's vehicle 100 is moving on a road RD that does not have lanes L, the position in the road width direction W of the driver's vehicle 100 to determine a driver's vehicle estimated route R1 can be, for example, a position determined or recommended by law, etc.

In addition, the moving object information obtaining part 22 obtains moving object information (step #03), and the attention-calling part 23 estimates a moving object estimated route R2 which is a future moving route of a moving object 90, based on the moving object information (step #04). The moving object estimated route R2 can be, for example, a route that is estimated without taking into account the presence of the driver's vehicle 100. When there are a plurality of moving objects 90 around the driver's vehicle 100, the attention-calling part 23 estimates future moving routes of the respective plurality of moving objects 90, assuming that the plurality of moving objects 90 move along routes in the future where the plurality of moving objects 90 do not interfere with each other.

For example, in the situation shown in FIG. 4, there are two moving objects 90, the first vehicle 91 and the second vehicle 92, around the driver's vehicle 100. The first vehicle 91 is moving on a lane L (first lane L1) adjacent to the lane L (second lane L2) on which the driver's vehicle 100 is moving, in the same direction as the driver's vehicle 100, and the second vehicle 92 is stopped in front of the first vehicle 91 on the lane L (first lane L1) on which the first vehicle 91 is moving. In the situation shown in FIG. 4, if the second vehicle 92 is moving at a higher speed than the first vehicle 91 and in the same direction as the first vehicle 91, or if the second vehicle 92 is not present, a moving route of the first vehicle 91 adopted when the first vehicle 91 continues to move on the first lane L1 at the same speed as the current speed in the future, too, can be set as a moving object estimated route R2 for the first vehicle 91. In this case, the position in the road width direction W of the first vehicle 91 to determine the moving object estimated route R2 can be, for example, the middle position of the first lane L1.

On the other hand, in the situation shown in FIG. 4, when the second vehicle 92 is present in addition to the first vehicle 91 and the first vehicle 91 continues to move on the first lane L1, there is a possibility that the first vehicle 91 and the second vehicle 92 bump into each other. Note that the configuration can be such that when, like the situation shown in FIG. 4, the moving speed of the second vehicle 92 (here, zero because the second vehicle 92 is stopped) is lower than the moving speed of the first vehicle 91 and the first risk potential distribution 61 set for the first vehicle 91 and the second risk potential distribution 62 set for the second vehicle 92 overlap each other, it is determined that there is a possibility that the first vehicle 91 and the second vehicle 92 bump into each other in the future. Note that a determination as to whether there is a possibility that two moving objects 90 bump into each other in the future can be a determination made based on future time-series changes in distance between the two moving objects 90, instead of a determination using risk potential distributions. For example, the configuration can be such that when the distance between two moving objects 90 is estimated to reach less than or equal to a preset threshold value in the future, it is determined that there is a possibility that the two moving objects 90 bump into each other in the future.

As such, in the situation shown in FIG. 4, there is a possibility that the first vehicle 91 and the second vehicle 92 bump into each other in the future. Hence, a moving route of the first vehicle 91 adopted when an operation of avoiding the second vehicle 92 (a lance change to the second lane L2) such as that shown in FIG. 4 is performed can be set as a moving object estimated route R2 for the first vehicle 91. In this case, the moving speed of the first vehicle 91 at each location along the moving object estimated route R2 can be estimated, for example, based on the current moving speed of the first vehicle 91 and drivers' general driving tendencies. On the other hand, since the second vehicle 92 is stopped, here, it is assumed that the second vehicle 92 continues to be stopped in the future, too. Note that unlike the situation shown in FIG. 4, when the second vehicle 92 is moving at a lower speed than the first vehicle 91, a moving object estimated route R2 is also estimated for the second vehicle 92. At this time, the moving object estimated route R2 for the first vehicle 91 and the moving object estimated route R2 for the second vehicle 92 are set so as not to interfere with each other. As such, the attention-calling part 23 estimates a closest approach point P (in an example shown in FIG. 4, a point where the driver's vehicle 100 and the first vehicle 91 make closest approach to each other in the future), assuming that a moving object (in the example shown in FIG. 4, the first vehicle 91) moves along a route in the future where the moving object does not interfere with a second moving object (in the example shown in FIG. 4, the second vehicle 92) different from the moving object.

Another situation shown in FIG. 6 will be described. In FIG. 6, there is a pedestrian 93 which is one moving object 90 around the driver's vehicle 100. Note that the fact that the moving object 90 is the pedestrian 93 can be determined based on information indicating the type of the moving object 90 included in moving object information. Here, a situation is assumed in which the pedestrian 93 attempts to cross a road RD on which the driver's vehicle 100 is moving. Whether or not the pedestrian 93 attempts to cross the road RD can be determined based on a current moving state of the pedestrian 93. For example, when the angle of intersection between a current moving direction of the pedestrian 93 and an extending direction of the road RD is greater than or equal to a threshold value, it can be determined that the pedestrian 93 attempts to cross the road RD. In this case, as shown in FIG. 6, a moving route of the pedestrian 93 adopted when the pedestrian 93 continues to move in the current moving direction in the future, too, can be set as a moving object estimated route R2 for the pedestrian 93. In addition, for example, when the angle of intersection between the current moving direction of the pedestrian 93 and the extending direction of the road RD is less than the above-described threshold value, it can be determined that the pedestrian 93 does not attempt to cross the road RD. In this case, a moving route of the pedestrian 93 adopted when the pedestrian 93 moves in the extending direction of the road RD from the current location of the pedestrian 93 (e.g., a moving route where the pedestrian 93 moves along an edge of the road RD) can be set as a moving object estimated route R2 for the pedestrian 93. Note that the moving speed of the pedestrian 93 at each location along the moving object estimated route R2 can be, for example, estimated based on the current moving speed of the pedestrian 93 or estimated to be the general moving speed of the pedestrian 93.

After completing the estimation of the driver's vehicle estimated route R1 (step #02) and the estimation of the moving object estimated route R2 (step #04), the attention-calling part 23 estimates a closest approach point P (step #05). The attention-calling part 23 estimates a closest approach point P based on the driver's vehicle estimated route R1 estimated based on the driver's vehicle information and the moving object estimated route R2 estimated based on the moving object information. As described above, when there are a plurality of moving objects 90 around the driver's vehicle 100, the attention-calling part 23 estimates future moving routes of the respective plurality of moving objects 90, assuming that the plurality of moving objects 90 move along routes in the future where the plurality of moving objects 90 do not interfere with each other. Thus, when there are a plurality of moving objects 90 around the driver's vehicle 100, the attention-calling part 23 estimates a closest approach point P, assuming that the plurality of moving objects 90 move along routes in the future where the plurality of moving objects 90 do not interfere with each other.

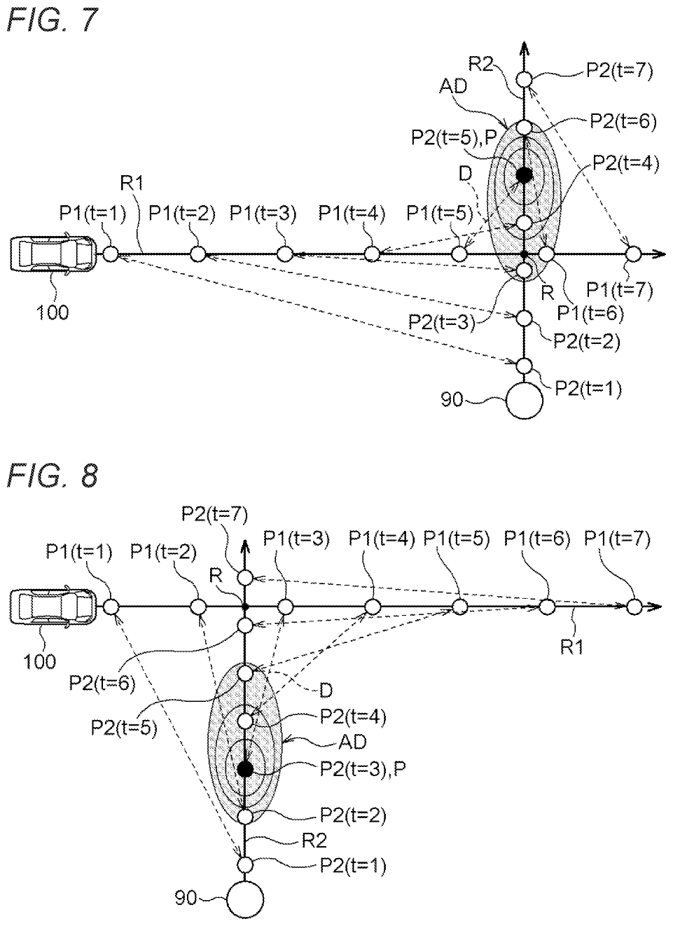

Upon estimating a driver's vehicle estimated route R1 at step #02, the attention-calling part 23 generates time-series data of driver's vehicle locations P1 which are the locations of the driver's vehicle 100. Namely, as shown in an example of FIG. 7, the driver's vehicle estimated route R1 is represented by time-series data of driver's vehicle locations P1. In addition, upon estimating a moving object estimated route R2 at step #04, the attention-calling part 23 generates time-series data of moving object locations P2 which are the locations of the moving object 90. Namely, as shown in the example of FIG. 7, the moving object estimated route R2 is represented by time-series data of moving object locations P2. As shown in FIG. 7, the time-series data of the driver's vehicle locations P1 and the time-series data of the moving object locations P2 are generated so as to have location data at the same time t. In FIG. 7, the time-series data of the driver's vehicle locations P1 and the time-series data of the moving object locations P2 are generated so as to have location data at each of seven times (t=1, 2, . . . , 7).

The attention-calling part 23 computes a distance between a driver's vehicle location P1 and a moving object location P2 (corresponding to the length of a dashed line arrow in FIG. 7) for each time t, and sets a time t at which the distance between the driver's vehicle location P1 and the moving object location P2 is shortest, as the point in time of closest approach at which the driver's vehicle 100 and the moving object 90 make closest approach to each other in the future (in other words, the distance between the driver's vehicle 100 and the moving object 90 is shortest in the future). Then, in the present embodiment, the attention-calling part 23 sets a moving object location P2 obtained at the point in time of closest approach, as a closest approach point P. In addition, the attention-calling part 23 estimates the above-described first direction X1 (see FIG. 5) which is the moving direction of the moving object 90 at the closest approach point P, based on the moving object estimated route R2. In the example of FIG. 7, time t=5 is the point in time of closest approach, and a moving object location P2 (t=5) at this point in time serves as a closest approach point P. In addition, in another example of FIG. 8, time t=3 is the point in time of closest approach, and a moving object location P2 (t=3) at this point in time serves as a closest approach point P. As such, the attention-calling part 23 is configured to set a location of the moving object 90 obtained at the point in time of closest approach, as a closest approach point P, based on future time-series changes in the distance between the driver's vehicle 100 and the moving object 90 which are estimated based on the driver's vehicle information and the moving object information.

After completing the estimation of the closest approach point P (step #05), the attention-calling part 23 determines whether a closest approach distance D (see FIGS. 7 and 8) which is a distance between the driver's vehicle 100 and the moving object 90 at the closest approach point P (in other words, a distance between the driver's vehicle 100 and the moving object 90 at the point in time of closest approach) is less than or equal to a predetermined display threshold value (step #06). Then, if the closest approach distance D is less than or equal to the predetermined display threshold value (step #06: Yes), the attention-calling part 23 allows the display part 5 to display an attention-calling marking M (step #07). As already described with reference to FIGS. 3 to 5, in the present embodiment, the attention-calling part 23 generates an attention call level distribution AD that distributes such that the attention call level A is highest at the closest approach point P and decreases as moving away from the closest approach point P, and allows the display part 5 to display an attention-calling marking M representing the generated attention call level distribution AD. On the other hand, if the closest approach distance D is greater than the display threshold value (step #06: No), the attention-calling part 23 ends the process without allowing the display part 5 to display an attention-calling marking M. Note that the magnitude of the display threshold value can be set, for example, to an upper limit value in a range of distance between the driver's vehicle 100 and the moving object 90 in which the moving object 90 influences travel of the driver's vehicle 100.

Note that the configuration can be such that when closest approach distances D for a plurality of moving objects 90 are less than or equal to the display threshold value, the display part 5 is allowed to display an attention-calling marking M for each of the plurality of moving objects 90 or the display part 5 is allowed to display attention-calling markings M for some moving objects 90. In the latter case, for example, the configuration can be such that the display part 5 is allowed to display an attention-calling marking M only for a moving object 90 whose closest approach point P is closest to the current location of the driver's vehicle 100 among the plurality of moving objects 90, in other words, only for a moving object 90 whose point in time of closest approach is earliest.

In FIGS. 7 and 8, a case is assumed in which the driver's vehicle estimated route R1 and the moving object estimated route R2 intersect each other like the situation shown in FIG. 6. In the following description, a point of intersection of the driver's vehicle estimated route R1 and the moving object estimated route R2 is a point of intersection of routes R. In a case in which when the driver's vehicle estimated route R1 and the moving object estimated route R2 thus intersect each other, the moving object 90 has not passed through the point of intersection of routes R at the point in time of closest approach, a situation occurs in which the moving object 90 approaches the driver's vehicle 100 that passes through the closest approach point P or a point near the closest approach point P. Hence, when the moving object 90 has not passed through the point of intersection of routes R at the point in time of closest approach (time t=3) like the example shown in FIG. 8, compared to a case in which the moving object 90 has passed through the point of intersection of routes R at the point in time of closest approach (time t=5) like the example shown in FIG. 7, even if the closest approach distances D have the same size, the influence of the moving object 90 on future travel of the driver's vehicle 100 is likely to increase. Hence, in the present embodiment, the display threshold value is set to be larger for a case in which the moving object 90 has not passed through the point of intersection of routes R at the point in time of closest approach compared to a case in which the moving object 90 has passed through the point of intersection of routes R at the point in time of closest approach. Note that instead of such a configuration, for example, the configuration may be such that the display threshold value is set to be larger for a case in which the driver's vehicle 100 passes through the point of intersection of routes R earlier than the moving object 90 compared to a case in which the moving object 90 passes through the point of intersection of routes R earlier than the driver's vehicle 100.

Meanwhile, in the present embodiment, information on patterns (templates) of an attention call level distribution AD is stored in the database 7, and the attention-calling part 23 places a pattern of an attention call level distribution AD obtained from the database 7 on a closest approach point P, and thereby generates an attention call level distribution AD that uses the closest approach point P as a reference. Then, the attention-calling part 23 allows the display part 5 to display an attention-calling marking M representing the generated attention call level distribution AD. In the present embodiment, a plurality of types of patterns of an attention call level distribution AD in which a region enclosed by a contour line C has an elliptical shape (see FIG. 5) are stored in the database 7. The plurality of types of patterns of an attention call level distribution AD include a plurality of types of patterns in which when a comparison is made between regions enclosed by contour lines C of the same height (magnitude of the attention call level A), the above-described lengths of the major axes of ellipses differ from each other. The attention-calling part 23 obtains, from the database 7, a pattern of an attention call level distribution AD in which the above-described length of the major axis increases as the moving speed of a moving object 90 at the point in time of closest approach increases, and places the obtained pattern of an attention call level distribution AD on a closest approach point P in a direction in which the major axis lies along the above-described first direction X1, and thereby generates an attention call level distribution AD that uses the closest approach point P as a reference.

In addition, in the present embodiment, the plurality of types of patterns of an attention call level distribution AD stored in the database 7 include a plurality of types of patterns in which the above-described lengths of the major axes of ellipses are the same but positional relationships of a position with the highest attention call level A with respect to the center of the above-described ellipse differ from each other. The attention-calling part 23 is configured to obtain, from the database 7, a pattern of an attention call level distribution AD set based on the time taken to reach the point in time of closest approach, and generate an attention call level distribution AD. In the example shown in FIG. 7, the time taken to reach the point in time of closest approach is relatively long, and thus, an attention call level distribution AD in which the position with the highest attention call level A is biased to a traveling direction side (first direction X1 side) of the moving object 90 is generated. In the example shown in FIG. 8, the time taken to reach the point in time of closest approach is relatively short, and thus, an attention call level distribution AD in which the position with the highest attention call level A is biased to an opposite side to a traveling direction of the moving object 90 (an opposite side to the first direction X1) is generated.

### OTHER EMBODIMENTS

Next, other embodiments of the vehicle driving assistance system will be described.

(1) The above-described embodiment describes, as an example, a configuration in which the display threshold value is set to be larger for a case in which the moving object 90 has not passed through the point of intersection of routes R at the point in time of closest approach compared to a case in which the moving object 90 has passed through the point of intersection of routes R at the point in time of closest approach. However, the configuration is not limited thereto, and the configuration can also be such that the magnitude of the display threshold value does not vary (i.e., the magnitude of the display threshold value is the same) between the case in which the moving object 90 has passed through the point of intersection of routes R at the point in time of closest approach and the case in which the moving object 90 has not passed through the point of intersection of routes R at the point in time of closest approach. In addition, the configuration can also be such that the display threshold value is set to be smaller for the case in which the moving object 90 has not passed through the point of intersection of routes R at the point in time of closest approach compared to the case in which the moving object 90 has passed through the point of intersection of routes R at the point in time of closest approach.

(2) The above-described embodiment describes, as an example, a configuration in which an attention-calling marking M is generated such that the length in the first direction X1 of the attention-calling marking M is long compared to the length in the second direction X2 orthogonal to the first direction X1. However, the configuration is not limited thereto, and the configuration can also be such that the attention-calling marking M is generated such that the length in the first direction X1 of the attention-calling marking M is equal to the length in the second direction X2, or such that the attention-calling marking M is generated such that the length in the first direction X1 of the attention-calling marking M is short compared to the length in the second direction X2.

(3) The above-described embodiment describes, as an example, a configuration in which the attention-calling marking M is displayed in a mode in which changes in attention call level A (in the above-described embodiment, the possibility of presence of a moving object 90) are shown in a stepwise manner. However, the configuration is not limited thereto, and the configuration can also be such that the attention-calling marking M is displayed in a mode in which changes in attention call level A are shown continuously. In this case, for example, the configuration can be such that the attention-calling marking M is displayed in a mode in which changes in attention call level A are shown in coloration gradation, etc.

(4) The above-described embodiment describes, as an example, a configuration in which the attention call level distribution AD is generated to be a distribution in which the attention call level A changes continuously. However, the configuration is not limited thereto, and the configuration can also be such that the attention call level distribution AD is generated to be a distribution in which the attention call level A changes in a stepwise manner. In this case, for example, the configuration can be such that the attention-calling marking M is displayed in a mode in which stepwise changes in attention call level distribution AD are shown as they are.

(5) The above-described embodiment describes, as an example, a configuration in which the attention-calling marking M is represented by a planar-shaped graphic lying along a road surface. However, the configuration is not limited thereto, and the configuration can also be such that the attention-calling marking M is represented by a graphic having a three-dimensional shape that spreads in a height direction, too (e.g., a mountain shape in which the magnitude of the attention call level A is represented by height from a road surface). In this case, it is preferred to adopt a configuration in which the attention-calling marking M is displayed in a mode in which the height from the road surface increases in a stepwise manner or continuously as the attention call level A increases.

(6) The above-described embodiment describes, as an example, a configuration in which a location of a moving object 90 at the point in time of closest approach is set as a closest approach point P. However, the configuration is not limited thereto, and a location other than the location of the moving object 90 at the point in time of closest approach can also be set as a closest approach point P. For example, a location of the driver's vehicle 100 at the point in time of closest approach can be set as a closest approach point P, or a midpoint location between the driver's vehicle 100 and the moving object 90 at the point in time of closest approach (e.g., a location equidistant from each of the driver's vehicle 100 and the moving object 90) can be set as a closest approach point P.

(7) The above-described embodiment describes, as an example, a case in which the attention call level A is the level of possibility of presence (probability of presence) of a moving object 90. However, the configuration is not limited thereto, and other indices may be used as long as the attention call level A is an index representing the level of influence of the moving object 90 on travel of the driver's vehicle 100. For example, the attention call level A may be an index representing the level of possibility of the moving object 90 colliding with the driver's vehicle 100.

(8) Assignment of each functional part of the vehicle driving assistance system 10 (arithmetic processing unit 4) shown in the above-described embodiment is merely an example, and it is also possible to combine a plurality of functional parts together or to further divide one functional part into a plurality of functional parts.

(9) Note that a configuration disclosed in each of the above-described embodiments can also be applied in combination with a configuration disclosed in another embodiment (including a combination of embodiments described as “other embodiments”) as long as a contradiction does not arise. For other configurations, too, the embodiments disclosed in this specification are in all respects as merely illustrative. Therefore, various modifications can be made as appropriate without departing from the true spirit of the present disclosure.

### OVERVIEW OF THE ABOVE-DESCRIBED EMBODIMENTS

An overview of a vehicle driving assistance system described above will be described below.

A vehicle driving assistance system (10) includes a display part (5) that displays an attention-calling marking (M) so as to be superimposed on a real view (S); a driver's vehicle information obtaining part (21) that obtains driver's vehicle information including information indicating a moving state of a driver's vehicle (100); a moving object information obtaining part (22) that obtains moving object information including information indicating a moving state of a moving object (90) around the driver's vehicle (100); and an attention-calling part (23) that allows the display part (5) to display the attention-calling marking (M) based on the driver's vehicle information and the moving object information, the attention-calling marking (M) using, as a reference, a closest approach point (P) where the driver's vehicle (100) and the moving object (90) make closest approach to each other in the future.

According to this configuration, by allowing the display part (5) to display an attention-calling marking (M), a driver of the driver's vehicle (100) can recognize the presence of a moving object (90) that can influence travel of the driver's vehicle (100). According to this configuration, an attention-calling marking (M) that uses, as a reference, a closest approach point (P) where the driver's vehicle (100) and the moving object (90) make closest approach to each other in the future, i.e., an attention-calling marking (M) that uses, as a reference, a point where the influence of the moving object (90) on travel of the driver's vehicle (100) can be greatest, can be displayed on the display part (5). Thus, compared to a case in which an attention-calling marking (M) that uses a current location of a moving object (90) as a reference is displayed on the display part (5), the driver of the driver's vehicle (100) can easily grasp a point where a moving object (90) around the driver's vehicle (100) can influence future travel of the driver's vehicle (100).

Here, it is preferred that the attention-calling part (23) estimate the closest approach point (P), assuming that the moving object (90) moves along a route in the future where the moving object (90) does not interfere with a second moving object different from the moving object (90).

When there are a moving object (90) and a second moving object different from the moving object (90) around the driver's vehicle (100), it is estimated that the moving object (90) moves so as to avoid interference with the second moving object (i.e., another moving object (90)). According to the above-described configuration, the closest approach point (P) can be appropriately estimated taking into account such an estimated moving route of the moving object (90).

In addition, it is preferred that the attention-calling part (23) set a location of the moving object (90) obtained at a point in time when a distance between the driver's vehicle (100) and the moving object (90) is shortest, as the closest approach point (P), based on future time-series changes in distance between the driver's vehicle (100) and the moving object (90), the future time-series changes being estimated based on the driver's vehicle information and the moving object information.

According to this configuration, the point in time when a distance between the driver's vehicle (100) and the moving object (90) is shortest can be estimated based on time-series changes in distance between the driver's vehicle (100) and the moving object (90). In the above-described configuration, since a location of the moving object (90) obtained at the point in time when a distance between the driver's vehicle (100) and the moving object (90) is shortest is set as a closest approach point (P) which serves as a reference of an attention-calling marking (M), the driver of the driver's vehicle (100) can grasp a location of the moving object (90) obtained at the point in time when the influence of the moving object (90) on travel of the driver's vehicle (100) can be greatest. Thus, the driver of the driver's vehicle (100) can easily perform a driving operation (e.g., an operation of avoiding the moving object (90)) that takes into account the presence of the moving object (90).

In addition, it is preferred that the attention-calling part (23) set a location of the moving object (90) obtained at a point in time when the driver's vehicle (100) and the moving object (90) make closest approach to each other, as the closest approach point (P), based on a future moving route (R1) of the driver's vehicle (100) estimated based on the driver's vehicle information and a future moving route (R2) of the moving object (90) estimated based on the moving object information.

According to this configuration, the point in time when the driver's vehicle (100) and the moving object (90) make closest approach to each other can be estimated based on a future moving route (R1) of the driver's vehicle (100) and a future moving route (R2) of the moving object (90). In the above-described configuration, since a location of the moving object (90) obtained at the point in time when the driver's vehicle (100) and the moving object (90) make closest approach to each other is set as a closest approach point (P) which serves as a reference of an attention-calling marking (M), the driver of the driver's vehicle (100) can grasp a location of the moving object (90) obtained at the point in time when the influence of the moving object (90) on travel of the driver's vehicle (100) can be greatest. Thus, the driver of the driver's vehicle (100) can easily perform a driving operation that takes into account the presence of the moving object (90).

In addition, it is preferred that the attention-calling part (23) allow the display part (5) to display the attention-calling marking (M) when a closest approach distance (D) is less than or equal to a predetermined display threshold value, and does not allow the display part (5) to display the attention-calling marking (M) when the closest approach distance (D) is greater than the display threshold value, the closest approach distance (D) being a distance between the driver's vehicle (100) and the moving object (90) at the closest approach point (P).

If an attention-calling marking (M) regarding the moving object (90) is displayed on the display part (5) when the influence of the moving object (90) on travel of the driver's vehicle (100) is not great, e.g., when an operation of avoiding the moving object (90) is not necessary, the driver of the driver's vehicle (100) may feel annoyed. According to the above-described configuration, a situation in which an attention-calling marking (M) is displayed on the display part (5) can be limited to a situation in which the moving object (90) can actually influence future travel of the driver's vehicle (100), and thus, display of an unnecessary attention-calling marking (M) can be suppressed.

In the configuration in which, as described above, the attention-calling part (23) allows the display part (5) to display the attention-calling marking (M) when the closest approach distance (D) is less than or equal to the threshold value, it is preferred that with a point of intersection of a future moving route (R1) of the driver's vehicle (100) and a future moving route (R2) of the moving object (90) being a point of intersection of routes (R), the display threshold value be set to be larger for a case in which the moving object (90) has not passed through the point of intersection of routes (R) at a point in time of closest approach compared to a case in which the moving object (90) has passed through the point of intersection of routes (R) at the point in time of closest approach, the point in time of closest approach being a point in time when the driver's vehicle (100) and the moving object (90) make closest approach to each other.

When the moving object (90) has not passed through the point of intersection of routes (R) at the point in time of closest approach, a situation occurs in which the moving object (90) approaches the driver's vehicle (100) that passes through the closest approach point (P) or a point near the closest approach point (P). Hence, when the moving object (90) has not passed through the point of intersection of routes (R) at the point in time of closest approach, compared to a case in which the moving object (90) has passed through the point of intersection of routes (R) at the point in time of closest approach, even if closest approach distances (D) have the same size, the influence of the moving object (90) on future travel of the driver's vehicle (100) is likely to increase. According to the above-described configuration, by setting the display threshold value taking into account this fact, in both of a case in which the moving object (90) has passed through the point of intersection of routes (R) at the point in time of closest approach and a case in which the moving object (90) has not passed through, an attention-calling marking (M) can be appropriately displayed on the display part (5) in a situation in which the moving object (90) can actually influence travel of the driver's vehicle (100).

In the vehicle driving assistance system (10) having the above-described configurations, it is preferred that the attention-calling marking (M) be a marking representing a level of possibility of presence of the moving object (90) at a point in time when the driver's vehicle (100) and the moving object (90) make closest approach to each other.

According to this configuration, the driver of the driver's vehicle (100) can easily grasp a location where there is a high possibility of presence of the moving object (90) at the point in time when the influence of the moving object (90) on travel of the driver's vehicle (100) can be greatest.

In the configuration in which, as described above, the attention-calling marking (M) is a marking representing the level of possibility of presence, it is preferred that the attention-calling marking (M) be a marking in which the possibility of presence at the closest approach point (P) is highest and the possibility of presence decreases as moving away from the closest approach point (P).

According to this configuration, the driver of the driver's vehicle (100) can more easily grasp a location where there is a high possibility of presence of the moving object (90) at the point in time when the influence of the moving object (90) on travel of the driver's vehicle (100) can be greatest.

In the vehicle driving assistance system (10) having the above-described configurations, it is preferred that a length in a moving direction (X1) of the moving object (90) of the attention-calling marking (M) be long compared to a length in a direction (X2) orthogonal to the moving direction (X1).

According to this configuration, an attention-calling marking (M) representing a region in which the driver's vehicle (100) and the moving object (90) can interfere with each other can be displayed on the display part (5), taking into account the fact that the location of presence of the moving object (90) is likely to vary in the moving direction (X1). Thus, the driver of the driver's vehicle (100) can easily perform a driving operation that takes into account the presence of the moving object (90).

In addition, it is preferred, but not necessary, that the moving object information include information indicating a type of the moving object (90).

According to this configuration, it becomes possible to appropriately estimate a closest approach point (P) or appropriately set the size and shape of an attention-calling marking (M), taking into account the fact that the moving tendency varies depending on the type of the moving object (90).

The vehicle driving assistance system (10) according to the present disclosure provides at least one of the above-described advantageous effects.

Various technical features of the above-described vehicle driving assistance system (10) are also applicable to a vehicle driving assistance method and a vehicle driving assistance program. For example, the vehicle driving assistance method can have steps having features of the above-described vehicle driving assistance system (10). In addition, the vehicle driving assistance program can cause a computer to implement functions having the features of the above-described vehicle driving assistance system (10). As a matter of course, these vehicle driving assistance method and vehicle driving assistance program can also provide the functions and effects of the above-described vehicle driving assistance system (10). Furthermore, various additional features exemplified as preferred modes of the vehicle driving assistance system (10) can also be incorporated into these vehicle driving assistance method and vehicle driving assistance program, and the method and the program can also provide functions and effects corresponding to the respective additional features.

### REFERENCE SIGNS LIST

5: Display part, 10: Vehicle driving assistance system, 21: Driver's vehicle information obtaining part, 22: Moving object information obtaining part, 23: Attention-calling part, 90: Moving object, 100: Driver's vehicle, D: Closest approach distance, M: Attention-calling marking, P: Closest approach point, R: Point of intersection of routes, R1: Driver's vehicle estimated route (future moving route of the driver's vehicle), R2: Moving object estimated route (future moving route of the moving object), S: Real view, X1: First direction (moving direction of the moving object), and X2: Second direction (direction orthogonal to the moving direction of the moving object)

1. A vehicle driving assistance system comprising:
a display part that displays an attention-calling marking so as to be superimposed on a real view;
a driver's vehicle information obtaining part that obtains driver's vehicle information including information indicating a moving state of a driver's vehicle;
a moving object information obtaining part that obtains moving object information including information indicating a moving state of a moving object around a driver's vehicle; and
an attention-calling part that allows the display part to display the attention-calling marking based on the driver's vehicle information and the moving object information, the attention-calling marking using, as a reference, a closest approach point where a driver's vehicle and the moving object make closest approach to each other in a future.

2. The vehicle driving assistance system according to claim 1, wherein the attention-calling part estimates the closest approach point, assuming that the moving object moves along a route in the future where the moving object does not interfere with a second moving object different from the moving object.

3. The vehicle driving assistance system according to claim 1, wherein the attention-calling part sets a location of the moving object obtained at a point in time when a distance between a driver's vehicle and the moving object is shortest, as the closest approach point, based on a future time-series change in distance between a driver's vehicle and the moving object, the future time-series change being estimated based on the driver's vehicle information and the moving object information.

4. The vehicle driving assistance system according to claim 1, wherein the attention-calling part sets a location of the moving object obtained at a point in time when a driver's vehicle and the moving object make closest approach to each other, as the closest approach point, based on a future moving route of a driver's vehicle estimated based on the driver's vehicle information and a future moving route of the moving object estimated based on the moving object information.

5. The vehicle driving assistance system according to claim 1, wherein the attention-calling part allows the display part to display the attention-calling marking when a closest approach distance is less than or equal to a predetermined display threshold value, and does not allow the display part to display the attention-calling marking when the closest approach distance is greater than the display threshold value, the closest approach distance being a distance between a driver's vehicle and the moving object at the closest approach point.

6. The vehicle driving assistance system according to claim 5, wherein
with a point of intersection of a future moving route of a driver's vehicle and a future moving route of the moving object being a point of intersection of routes,
the display threshold value is set to be larger for a case in which the moving object has not passed through the point of intersection of routes at a point in time of closest approach compared to a case in which the moving object has passed through the point of intersection of routes at the point in time of closest approach, the point in time of closest approach being a point in time when a driver's vehicle and the moving object make closest approach to each other.

7. The vehicle driving assistance system according to claim 1, wherein the attention-calling marking is a marking representing a level of possibility of presence of the moving object at a point in time when a driver's vehicle and the moving object make closest approach to each other.

8. The vehicle driving assistance system according to claim 7, wherein the attention-calling marking is a marking in which the possibility of presence at the closest approach point is highest and the possibility of presence decreases as moving away from the closest approach point.

9. The vehicle driving assistance system according to claim 1, wherein a length in a moving direction of the moving object of the attention-calling marking is long compared to a length in a direction orthogonal to the moving direction.

10. The vehicle driving assistance system according to claim 1, wherein the moving object information includes information indicating a type of the moving object.

11. A vehicle driving assistance method comprising:
a displaying step of allowing a display part to display an attention-calling marking so as to be superimposed on a real view;
a driver's vehicle information obtaining step of obtaining driver's vehicle information including information indicating a moving state of a driver's vehicle;
a moving object information obtaining step of obtaining moving object information including information indicating a moving state of a moving object around a driver's vehicle; and
an attention-calling step of allowing the display part to display the attention-calling marking based on the driver's vehicle information and the moving object information, the attention-calling marking using, as a reference, a closest approach point where a driver's vehicle and the moving object make closest approach to each other in a future.

12. A vehicle driving assistance program stored on a non-transitory computer readable medium causing a computer to implement:
a display function of allowing a display part to display an attention-calling marking so as to be superimposed on a real view;
a driver's vehicle information obtaining function of obtaining driver's vehicle information including information indicating a moving state of a driver's vehicle;
a moving object information obtaining function of obtaining moving object information including information indicating a moving state of a moving object around a driver's vehicle; and
an attention-calling function of allowing the display part to display the attention-calling marking based on the driver's vehicle information and the moving object information, the attention-calling marking using, as a reference, a closest approach point where a driver's vehicle and the moving object make closest approach to each other in a future.
